(19) United States
(12) Patent Application Publication
(10) Pub. No.: US 2015/0052567 A1
(43) Pub. Date: Feb. 19, 2015

(54) APPARATUS FOR REQUESTING BLACK BOX IMAGES OVER DIGITAL MULTIMEDIA BROADCASTING NETWORK, AND APPARATUS AND METHOD FOR SEARCHING BLACK BOX IMAGES

(71) Applicant: Electronics and Telecommunications Research Institute, Daejeon (KR)

(72) Inventor: Juwan KIM, Daejeon (KR)

(21) Appl. No.: 14/444,197

(22) Filed: Jul. 28, 2014

(30) Foreign Application Priority Data
Aug. 19, 2013 (KR) 10-2013-0098180

(51) Int. Cl. H04N 21/6377; H04N 21/2343; H04N 21/643

(52) U.S. Cl. CPC H04N 21/6377; H04N 21/643; H04N 21/2343
USPC 725/86

(57) ABSTRACT

An apparatus for requesting black box images over a digital multimedia broadcasting (DMB) network, and an apparatus and method for searching black box images are disclosed. The apparatus for requesting black box images over a DMB network includes a request generation unit, an encoding unit, and a request transmission unit. The request generation unit generates information about a request for black box images to be collected. The encoding unit encodes the generated image request information into format suitable for transmission via a DMB data broadcast. The request transmission unit transmits the encoded image request information to apparatuses for searching black box images mounted on one or more vehicles through DMB broadcasting centers.

### CROSS REFERENCE TO RELATED APPLICATION

This application claims the benefit of Korean Patent Application No. 10-2013-0098180, filed on Aug. 19, 2013, which is hereby incorporated by reference herein in its entirety.

### BACKGROUND OF THE INVENTION

1. Technical Field

The present disclosure relates to an apparatus for requesting black box images over a digital multimedia broadcasting (DMB) network, and an apparatus and method for searching black box images in response to a request from the apparatus for requesting black box images.

2. Description of the Related Art

In general, car black boxes are devices that capture, store and play back a variety of types of scenes of car accidents. When a car accident occurs, images of the accident are searched in a black box and then the situation of the accident is analyzed. However, when a car accident occurs, it is not easy to obtain black box images due to the management of the scene of the accident. Furthermore, it is very difficult to obtain images stored in a black box mounted on another vehicle that passes through the scene of the accident at the time of the accident.

Currently, although various media, such as a placard, a banner and a broadcast, are utilized in order to obtain the black box images of vehicles having passed through the scene of an accident at the time when a car accident occurred, it is difficult for drivers to become aware of advertisements requesting black box content while driving.

Furthermore, Korean Patent Application Publication 10-2011-0037047 discloses a technology that, when a central server requests accident-related images, provides images stored in a black box to the central server. However, this technology is disadvantageous in that it is difficult to request and obtain images stored in the black box of another vehicle in practice because the procedure is very complicated and it is difficult for a driver to directly search the images of a black box.

### SUMMARY OF THE INVENTION

At least one embodiment of the present invention is intended to provide an apparatus and method that periodically transmit black box image request information to a plurality of vehicles having passed through the scene of an accident over a DMB data broadcasting network, and search and provide black box images when the black box image request information is received over the DMB data broadcasting network.

In accordance with an aspect of the present invention, there is provided an apparatus for requesting black box images over a DMB network, including a request generation unit configured to generate information about a request for black box images to be collected; an encoding unit configured to encode the generated image request information into format suitable for transmission via a DMB data broadcast; and a request transmission unit configured to transmit the encoded image request information to apparatuses for searching black box images mounted on one or more vehicles through DMB broadcasting centers.

Image request information may include one or more of an accident occurrence location, an accident occurrence time, offset information related to the accident occurrence location and time, and request details that are generated based on the received car accident information.

The request transmission unit may receive information about vehicles having passed through the accident occurrence location at the accident occurrence time from a connected system, and may transmit the image request information to apparatuses for searching black box images of the vehicles included in the received information.

The format suitable for transmission via a DMB data broadcast may include TPEG data format.

In accordance with another aspect of the present invention, there is provided an apparatus for searching black box images, including an image search unit configured to, once image request information has been received from an apparatus for requesting black box images over a DMB network, search images stored in a box black and read meta-information; an image determination unit configured to determine images to be transmitted to the apparatus for requesting black box images based on the meta-information and the image request information; and an image transmission unit configured to transmit the determined images to the apparatus for requesting black box images.

The image request information may include one or more of a location, a time, offset information related to the location and time, and request details.

The image determination unit may compare a time or location condition determined based on the time, the location and the offset information with time or location information included in meta-information of each of the found images, and, if an overlap is present in the found image, may determine the found image to be an image to be transmitted to the apparatus for requesting black box images.

The image determination unit may generate a list of images to be transmitted to the apparatus for requesting black box images, and, if images included in the generated image list are two or more in number, may provide the image list to a user.

The image determination unit may provide the image request information to the user along with the image list, and, if one or more images are selected by the user, may determine the selected one or more images to be images to be transmitted to the apparatus for requesting black box images.

In accordance with still another aspect of the present invention, there is provided a method of searching black box images, including, once image request information has been received from an apparatus for requesting black box images over a DMB network, searching images stored in a box black and reading meta-information; determining images to be transmitted to the apparatus for requesting black box images based on the meta-information and the image request information; and transmitting the determined images to the apparatus for requesting black box images.

The image request information may include one or more of a location, a time, offset information related to the location and time, and request details.

Determining the images to be transmitted may include comparing a time or location condition determined based on the time, the location and the offset information with time or location information included in meta-information of each of the found images; and, if an overlap is present in the found image, determining the found image to be an image to be transmitted to the apparatus for requesting black box images.

Determining the images to be transmitted may include generating a list of images to be transmitted to the apparatus for requesting black box images; and, if images included in the generated image list are two or more in number, providing the image list to a user.

Providing the image list may include providing the image request information to the user along with the image list; and, if one or more images are selected by the user, determining the selected one or more images to be images to be transmitted to the apparatus for requesting black box images.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a diagram of a black box image collection system according to an embodiment of the present invention;

FIG. 2 is a block diagram of an apparatus for requesting black box images according to an embodiment of the present invention;

FIGS. 3 and 4 are diagrams of image request information according to an embodiment of the present invention;

FIG. 5 is a block diagram of an apparatus for searching black box images according to an embodiment of the present invention;

FIG. 6 is a flowchart of a method of requesting black box images according to an embodiment of the present invention;

FIG. 7 is a flowchart of a method of searching black box images according to an embodiment of the present invention; and

FIG. 8 is a detailed flowchart of the image determination step of the method of searching black box images illustrated in FIG. 7.

### DESCRIPTION OF THE PREFERRED EMBODIMENTS

Reference now should be made to the drawings, throughout which the same reference numerals are used to designate the same or similar components.

An apparatus for requesting black box images over a DMB network, and an apparatus and method for searching black box images according to embodiments of the present invention are described in detail below with reference to the accompanying drawings.

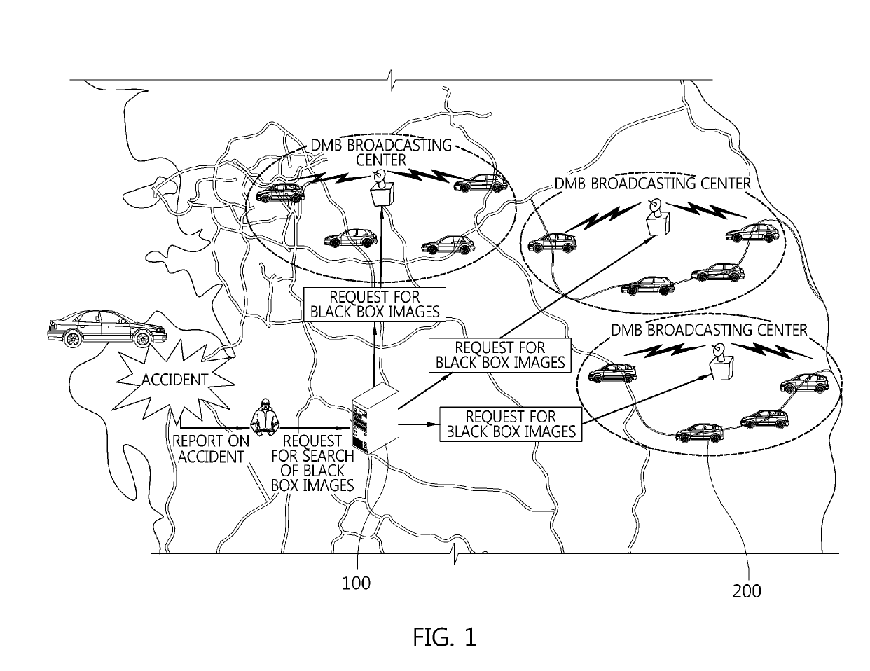

FIG. 1 is a diagram of a black box image collection system according to an embodiment of the present invention.

Referring to FIG. 1, a black box image collection system may include an apparatus 100 for requesting black box images, and a plurality of apparatuses 200 for searching black box images.

When a report on a car accident is received, a person who receives the report may register received car accident information, for example, a car accident location, a car accident occurrence time, car accident details, the license plate number of a vehicle involved in the accident, etc., in the apparatus 100 for requesting black box images.

The apparatus 100 for requesting black box images may generate black box image request information in order to request black box images required to analyze a the cause of an accident using the registered car accident information. In this case, the black box image request information may include a location, a time, offset information related to the location and the time, and request details.

The apparatus 100 for requesting black box images may encode the generated black box image request information, together with TPEG(Transport Protocol Expert Group) data, into DMB broadcast data, and may periodically transmit the encoded black box image request information to the plurality of apparatuses 200 for searching black box images, which are mounted on respective vehicles, through DMB broadcasting centers in respective areas.

The apparatuses 200 for searching black box images, which are mounted on respective vehicles, receive the black box image request information from the apparatus 100 for requesting black box images through internal DMB reception modules or connected external DMB reception modules.

When the black box image request information is received, each of the apparatuses 200 for searching black box images may search images stored in a black box mounted on its vehicle, and may transmit a corresponding image to the apparatus 100 for requesting black box images.

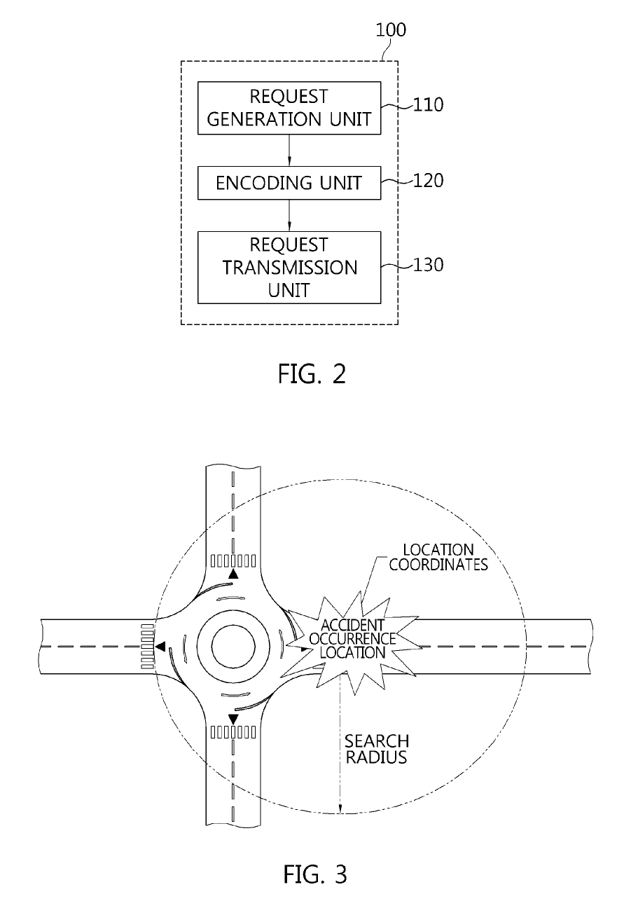

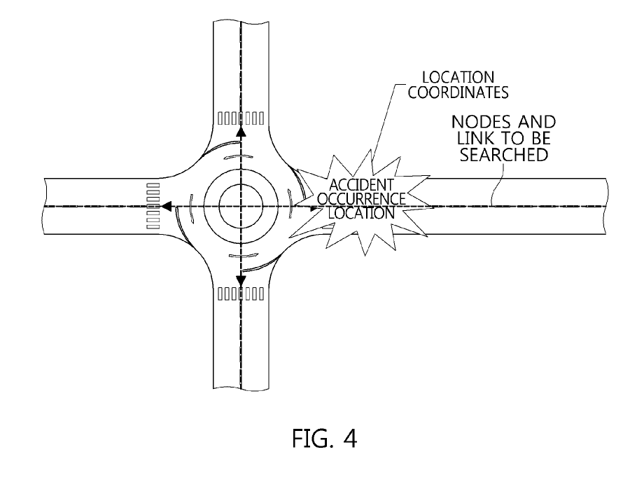

FIG. 2 is a block diagram of an apparatus for requesting black box images according to an embodiment of the present invention. FIGS. 3 and 4 are diagrams of image request information according to an embodiment of the present invention.

Referring to FIG. 2, an apparatus 100 for requesting black box images may include a request generation unit 110, an encoding unit 120, and a request transmission unit 130.

The request generation unit 110 generates information about a request for black box images to be collected. The request information may include one or more of an accident location, an accident occurrence time, offset information related to the accident location and the accident occurrence time, and request details generated based on the received car accident information, as described above.

In this case, the offset information related to an occurrence time may be time interval information that is used by the apparatus 200 for searching black box images to designate a search time range. For example, if the occurrence time is “t” and the offset is 5 minutes, the search time range may be determined to be a range from t−5 to t+5.

The occurrence location may be information about the coordinates of a car accident occurrence point. Furthermore, the offset information about the occurrence location may be information about a radius around an occurrence location (e.g., 1 km, 2 km, or the like), as illustrated in FIG. 3. Alternatively, the offset information may be node and link information including the occurrence location, as illustrated in FIG. 4. For example, specific landmarks on a road may be set to nodes, a connection between corresponding nodes may be set to a link, and information about two nodes including accident occurrence location and a link connecting the nodes are generated as offset information.

When the black box image request information is generated, the encoding unit 120 may encode the request information into format suitable for transmission via DMB data broadcasting. In this case, DMB data broadcasting format may include data format that is defined in TPEG technology.

The request transmission unit 130 may transmit black the box image request information encoded in DMB data broadcasting format to the apparatuses 200 for searching black box images installed in a plurality of vehicles that have passed through the scene of the accident.

The request transmission unit 130 may check information about vehicles having passed through the accident occurrence location before, on and after the accident occurrence time using the received car accident information, and may transmit image request information requesting black box images from the apparatuses 200 for searching black box images installed in the identified vehicles.

In this case, the request transmission unit 130 may transmit the accident occurrence time and location information to a connected system, and may receive vehicle information from the connected system. The connected system may collect images of road conditions from CCTV cameras installed on roads. When receiving the accident occurrence time and location information from the request transmission unit 130, the connected system may provide corresponding vehicle information to the request transmission unit 130.

Meanwhile, the apparatus 100 for requesting black box images may function to collect road conditions from imaging devices, such as CCTV cameras, installed on roads. In this case, the request transmission unit 130 may check information about vehicles having passed through the accident occurrence location at the accident occurrence time from the collected road condition images without requesting vehicle information from the separate connected system.

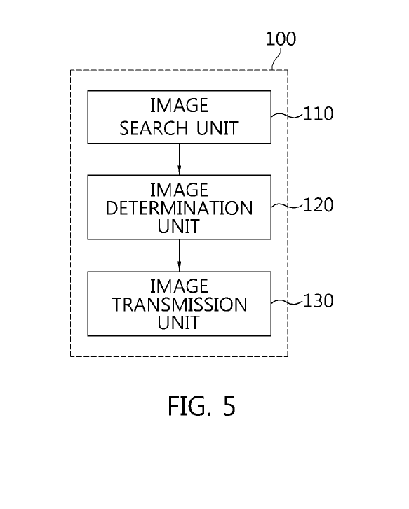

FIG. 5 is a block diagram of an apparatus 200 for searching black box images according to an embodiment of the present invention.

The apparatus 200 for searching black box images that receives black box image request information from the apparatus 100 for requesting black box images may be a car navigation terminal or a black box terminal mounted on a vehicle. Alternatively, the apparatus 200 for searching black box images may be an apparatus that is separate from a car navigation terminal or a black box terminal and that is configured to operate in conjunction with a black box terminal or a car navigation terminal.

Furthermore, the apparatus 200 for searching black box images may be configured to include a DMB reception module therein, or to operate in conjunction with a DMB reception module located outside the apparatus 200 for searching black box images.

Referring to FIG. 5, the apparatus 200 for searching black box images may include an image search unit 210, an image determination unit 220, and an image transmission unit 230.

When a DMB broadcast reception module receives black box image request information from the apparatus 100 for requesting black box images over a DMB network, the image search unit 210 may search images stored in a black box, and may read meta-information recorded in connection with the images.

Meanwhile, if necessary, as in the case where a black box is separately implemented and operates in conjunction with the apparatus 200 for searching images, the image search unit 210 may request meta-information of the images from the black box and then receive the meta-information from the black box.

In this case, the meta-information may include time and location information related to the images stored in the black box.

The image determination unit 220 may generate time and location conditions based on time, location and offset information included in the image request information. For example, as described above, a search time range (e.g., from t−5 to t+5) may be generated as the time condition by adding an offset (e.g., 5 minutes) before and after a specific time (e.g., t). Furthermore, a search location range may be generated as the location condition by reflecting offset information (e.g., radius information, link information, etc.) in the coordinates of a specific location.

The image determination unit 220 may compare the determined time and location conditions with time and location information included in the meta-information of found images, and may determine found images having overlaps to be images to be transmitted to the apparatus 100 for requesting black box images.

The following Table 1 illustrates images stored in the black box of a vehicle that has received black box image request information from the apparatus for requesting images:

TABLE 1

| Image | Recorded time | Recorded location |
|---|---|---|
| IMG_1 | 11:52 to 11:55 | A to B |
| IMG_2 | 11:55 to 11:58 | B to C |
| IMG_3 | 11:58 to 12:01 | C to D |
| IMG_4 | 12:01 to 12:04 | D to E |
| IMG_5 | 12:04 to 12:07 | E to F |
| IMG_6 | 12:07 to 12:10 | F to G |

In this case, if the section from A to B is 1 km, the section from B to C is 1.2 km, the section from C to D is 0.5 km, the section from D to E is 1.3 km, the section from E to F is 0.8 km, the section from F to G is 0.5 km, a search condition generated by the image determination unit 220, that is, a time condition, is 11:55 to 12:05, and a location condition is a radius of 1 km around location D, IMG_{—}2, IMG_{—}3 and IMG_{—}4 are determined to be images to be transmitted.

That is, the image determination unit 220 obtains IMG_{—}2, IMG_{—}3, IMG_{—}4 and IMG_{—}5 including overlaps by comparing the time condition with the time information of the meta-information, obtains IMG_{—}2, IMG_{—}3 and IMG_{—}4 having overlaps by comparing the location condition with the location information of the meta-information, and finally determines IMG_{—}2, IMG_{—}3 and IMG_{—}4 that satisfy the time and location conditions to be images to be transmitted.

Meanwhile, the image determination unit 220 may generate a list of images determined to be images to be transmitted, and may provide the image list to the user of the black box if two or more found images are present in the image list. In this case, the image determination unit 220 may provide the image request information received from the apparatus 100 for requesting black box images to the user along with the image list.

The user may check the image list and the image request information output from a display, and may select images to be transmitted to the apparatus 100 for requesting black box images. When one or more images are selected by the user, the image determination unit 220 may determine the selected images to be images to be transmitted to the apparatus 100 for requesting black box images.

The image transmission unit 230 transmits the images determined by the image determination unit 220 to the apparatus 100 for requesting black box images.

In accordance with the disclosed embodiment, black box images of the scene of an accident are requested from vehicles having passed through the scene of the accident over a DMB network, and the vehicles that have received the black box image request automatically search black box images and provide required black box images. Accordingly, black box images can be very effectively collected from a plurality of vehicles, and thus the reason of the accident can be rapidly determined

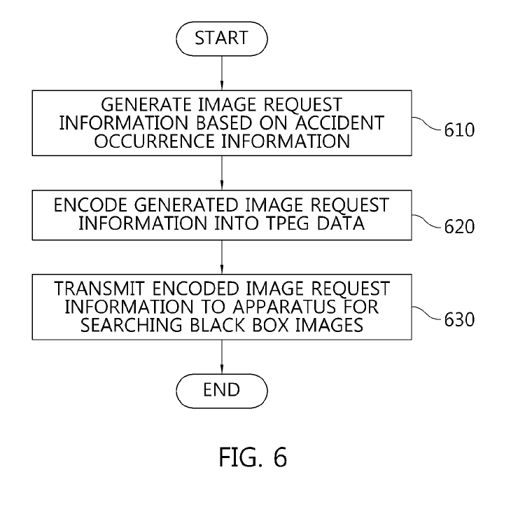

FIG. 6 is a flowchart of a method of requesting black box images according to an embodiment of the present invention.

The method of requesting black box images illustrated in FIG. 6 may be performed by the apparatus 100 for requesting black box images according to the embodiment of FIG. 2.

First, when car accident information is received, request information including an occurrence location, an occurrence time, an offset, and request details is generated with respect to black box images to be collected based on the car accident information at step 610.

Once the black box image request information has been generated, the image request information is encoded into DMB data format, for example, TPEG data format, at step 620.

Thereafter, the black box image request information encoded into DMB data broadcasting format is transmitted to a plurality of vehicles that have passed through the scene of the accident at step 630.

In this case, when car accident information is received, information about vehicles that have passed through the accident occurrence location after, on and before the accident occurrence time may be obtained first. For example, if the apparatus for requesting black box images collects road condition information in conjunction with imaging devices, such as CCTV cameras, installed on roads, the vehicle information may be obtained from the collected road condition information. Alternatively, in conjunction with an external road condition information collection system, car accident information may be transmitted to the road condition information collection system, and vehicle information may be received from the road condition information collection system.

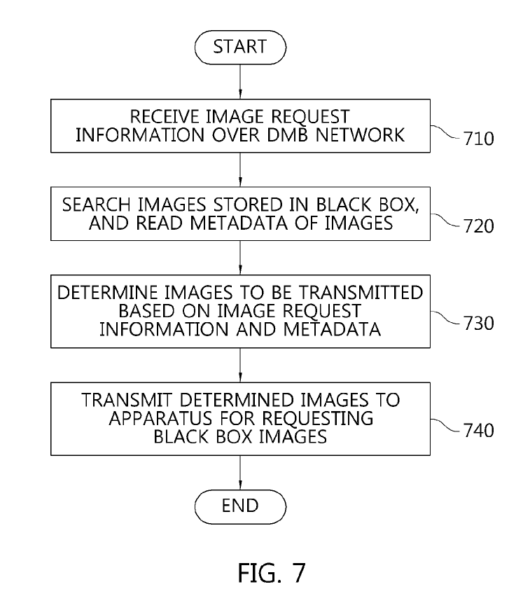

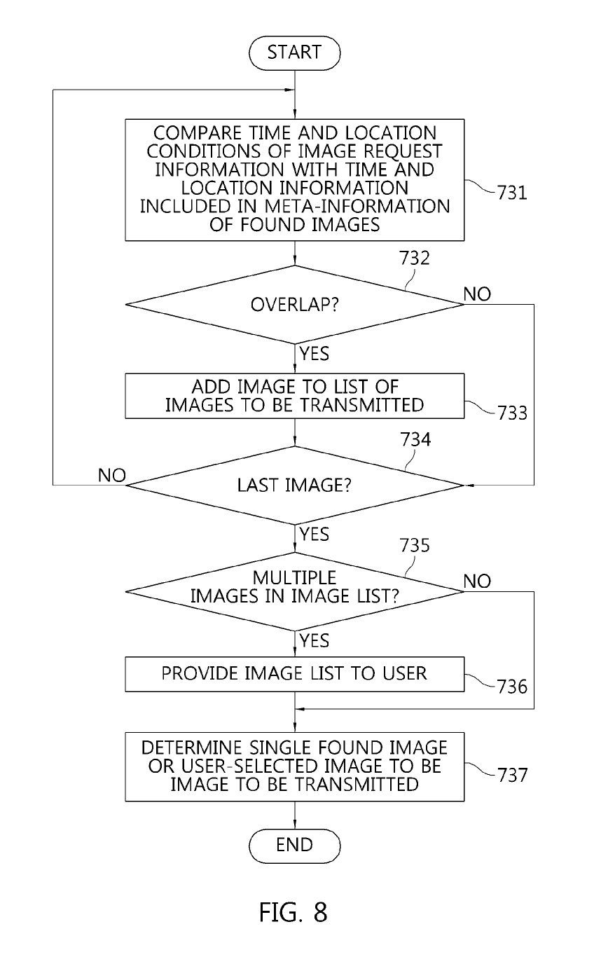

FIG. 7 is a flowchart of a method of searching black box images according to an embodiment of the present invention. FIG. 8 is a detailed flowchart of the image determination step of the method of searching black box images illustrated in FIG. 7.

The method of searching black box images illustrated in FIGS. 7 and 8 may be an example of a method that is performed by the apparatus 200 for searching black box images according to the embodiment of FIG. 5.

First, the apparatus 200 for searching black box images receives black box image request information via an internal or connected external DMB reception module over a DMB network at step 710.

Once the black box image request information has been received, images stored in a black box may be searched and meta-information, including the recorded time and location information of the images, may be read at step 720. In this case, as described above, when the operation is performed in conjunction with an external black box, the meta-information of the images may be requested from the black box and meta-information may be received from the black box.

Thereafter, images to be transmitted are determined based on the image request information and the read meta-information at step 730.

An example of the image determination of step 730 will be more specifically described with reference to FIG. 8. First, once the time and location conditions of the image request information are determined as described above, the time and location conditions are compared with time and location information included in the meta-information of each of the found images at step 731.

Thereafter, if, as a result of the comparison at step 731, it is determined at step 732 that an overlap is present in the found image, the found image is added to a list of images to be transmitted at step 733.

Thereafter, it is determined that the found image is an image stored in the black box at step 734. Meanwhile, if, as a result of the comparison at step 731, it is determined step 732 that an overlap is not present in the found image, it is determined that the found image is a last image at step 734.

Thereafter, if it is determined at step 734 that the found image is not a last image, the process returns to step 731 at which comparison with the meta-information of a subsequent found image is performed.

In this case, if it is determined at step 734 that the found image is a last image, it is determined whether two or more images are present in the generated image list at step 735.

Thereafter, if two or more images are not present in the image list, a single image present in the image list may be determined to be an image to be transmitted at step 737.

If, as a result of the determination at step 735, it is determined that two or more images are present in the image list, the image list is provided to the user at step 736. In this case, the image list may be provided along with the received image request information.

Thereafter, when the user checks the image list and image request information and selects one or more images to be transmitted, the selected images may be determined to be images to be transmitted to the apparatus for requesting black box images at step 737.

Referring to FIG. 6 again, once the images to be transmitted to the apparatus for requesting black box images have been determined, the images may be transmitted to the apparatus for requesting black box images at step 740.

In accordance with at least one embodiment of the present invention, black box image request information is periodically transmitted to vehicles having passed through the scene of an accident over a DMB network used by most vehicles, and black box images are searched and provided in response to the request, thereby rapidly and easily collecting black box images of the scene of the accident from a plurality of vehicles that have passed through the scene of the accident.

Although the preferred embodiments of the present invention have been disclosed for illustrative purposes, those skilled in the art will appreciate that various modifications, additions and substitutions are possible without departing from the scope and spirit of the invention as disclosed in the accompanying claims.

What is claimed is:

1. An apparatus for requesting black box images over a digital multimedia broadcasting (DMB) network, comprising:
a request generation unit configured to generate information about a request for black box images to be collected;
an encoding unit configured to encode the generated image request information into format suitable for transmission via a DMB data broadcast; and
a request transmission unit configured to transmit the encoded image request information to apparatuses for searching black box images mounted on one or more vehicles through DMB broadcasting centers.

2. The apparatus of claim 1, wherein the image request information includes one or more of an accident occurrence location, an accident occurrence time, offset information related to the accident occurrence location and time, and request details that are generated based on the received car accident information.

3. The apparatus of claim 2, wherein the request transmission unit receives information about vehicles having passed through the accident occurrence location at the accident occurrence time from a connected system, and transmits the image request information to apparatuses for searching black box images of the vehicles included in the received information.

4. The apparatus of claim 1, wherein the format suitable for transmission via a DMB data broadcast includes TPEG data format.

5. An apparatus for searching black box images, comprising:
an image search unit configured to, once image request information has been received from an apparatus for requesting black box images over a DMB network, search images stored in a box black and read meta-information;
an image determination unit configured to determine images to be transmitted to the apparatus for requesting black box images based on the meta-information and the image request information; and
an image transmission unit configured to transmit the determined images to the apparatus for requesting black box images.

6. The apparatus of claim 5, wherein the image request information includes one or more of a location, a time, offset information related to the location and time, and request details.

7. The apparatus of claim 6, wherein the image determination unit compares a time or location condition determined based on the time, the location and the offset information with time or location information included in meta-information of each of the found images, and, if an overlap is present in the found image, determines the found image to be an image to be transmitted to the apparatus for requesting black box images.

8. The apparatus of claim 5, wherein the image determination unit generates a list of images to be transmitted to the apparatus for requesting black box images, and, if images included in the generated image list are two or more in number, provides the image list to a user.

9. The apparatus of claim 8, wherein the image determination unit provides the image request information to the user along with the image list, and, if one or more images are selected by the user, determines the selected one or more images to be images to be transmitted to the apparatus for requesting black box images.

10. A method of searching black box images, comprising:
once image request information has been received from an apparatus for requesting black box images over a DMB network, searching images stored in a box black and reading meta-information;
determining images to be transmitted to the apparatus for requesting black box images based on the meta-information and the image request information; and
transmitting the determined images to the apparatus for requesting black box images.

11. The method of claim 10, wherein the image request information includes one or more of a location, a time, offset information related to the location and time, and request details.

12. The method of claim 11, wherein determining the images to be transmitted comprises:
comparing a time or location condition determined based on the time, the location and the offset information with time or location information included in meta-information of each of the found images; and
if an overlap is present in the found image, determining the found image to be an image to be transmitted to the apparatus for requesting black box images.

13. The method of claim 10, wherein determining the images to be transmitted comprises:
generating a list of images to be transmitted to the apparatus for requesting black box images; and
if images included in the generated image list are two or more in number, providing the image list to a user.

14. The method of claim 13, wherein:
providing the image list includes providing the image request information to the user along with the image list; and
if one or more images are selected by the user, determining the selected one or more images to be images to be transmitted to the apparatus for requesting black box images.
